(19) United States
(12) Patent Application Publication
(10) Pub. No.: US 2011/0200886 A1
(43) Pub. Date: Aug. 18, 2011

(54) NON-AQUEOUS ELECTROLYTE AND NON-AQUEOUS ELECTROLYTE SECONDARY BATTERY USING THE SAME

(76) Inventor: Masaki Deguchi, Hyogo (JP)

(21) Appl. No.: 13/126,364

(22) PCT Filed: Sep. 9, 2010
(86) PCT No.: PCT/JP2010/005511

§ 371 Date: Apr. 27, 2011

(30) Foreign Application Priority Data
Sep. 29, 2009 (JP) 2009-223624

(51) Int. Cl. H01M 10/056; H01M 4/60; H01M 4/583

(52) U.S. Cl. 429/331; 429/212

(57) ABSTRACT

A non-aqueous electrolyte including a non-aqueous solvent and a solute dissolved in the non-aqueous solvent. The non-aqueous solvent includes ethylene carbonate, propylene carbonate, diethyl carbonate, and a first additive. The weight percentage W_{PC} of the propylene carbonate relative to a total of the ethylene carbonate, propylene carbonate, and diethyl carbonate is 30 to 60% by weight. The ratio W_{Pc}/W_{PC} of the weight percentage W_{PC} of the propylene carbonate to a weight percentage W_{EC} of the ethylene carbonate relative to the total satisfies 2.25≦W_{PC}/W_{PC}≦6. The first additive includes at least one of an unsaturated sultone and a sulfonic acid ester, and the weight percentage of the first additive in the whole non-aqueous electrolyte is 0.1 to 3% by weight.

### TECHNICAL FIELD

The present invention relates to non-aqueous electrolytes and non-aqueous electrolyte secondary batteries, and particularly relates to a non-aqueous electrolyte contributing to suppression of gas generation in a non-aqueous electrolyte secondary battery.

### BACKGROUND ART

A non-aqueous electrolyte contained in a non-aqueous electrolyte secondary battery represented by a lithium ion secondary battery includes a non-aqueous solvent and a solute dissolved in the non-aqueous solvent. For the solute, for example, lithium hexafluorophosphate (LiPF₆) or lithium tetrafluoroborate (LiBF₄) is used.

The non-aqueous solvent includes, for example, a chain carbonate, a cyclic carbonate, a cyclic carboxylic acid ester, a chain ether, or a cyclic ether. Examples of the chain carbonate include diethyl carbonate (DEC). Examples of the cyclic carbonate include ethylene carbonate (EC), propylene carbonate (PC), and vinylene carbonate (VC). A cyclic carbonate such as EC and PC has a high dielectric constant, which is advantageous in providing excellent lithium ion conductivity, but, because of its high viscosity, is usually used by mixing it with a chain carbonate such as DEC whose viscosity is low.

In a non-aqueous electrolyte secondary battery, a carbon material is typically used as a negative electrode material. The carbon material causes a side reaction with the non-aqueous electrolyte as described above, which may possibly cause the battery characteristics to be deteriorated. In particular, when a non-aqueous electrolyte with high PC content is used, the negative electrode is easily deteriorated in association with the decomposition of PC. It is important, therefore, to allow a coating film (or a solid electrolyte interface (SEI)) to be formed on the surface of the negative electrode so that the side reaction between the carbon material and the non-aqueous electrolyte can be inhibited. Further, since the coating film has influence on the battery characteristics, it is also important to control the properties of the coating film. The disclosed techniques relating to the coating film are described below.

Patent Literature 1 discloses that VC and 1,3-propane sultone (PS) are included as additives for forming a coating film, in a non-aqueous solvent containing PC.

Patent Literature 2 discloses a non-aqueous electrolyte containing an unsaturated sultone as an additive. It is disclosed that the use of an unsaturated sultone makes it possible to provide a battery having excellent high-temperature storage characteristics.

Patent Literature 3 discloses a non-aqueous electrolyte containing a cyclic carboxylic acid ester and a sulfonic acid derivative as additives. It is disclosed that this makes it possible to provide a battery having excellent high-temperature storage characteristics.

### CITATION LIST

### Patent Literature

[PTL 1] Japanese Laid-Open Patent Publication No. 2004-355974
[PTL 2] Japanese Laid-Open Patent Publication No. 2002-329528
[PTL 3] Japanese Laid-Open Patent Publication No. 2002-343426

### SUMMARY OF INVENTION

### Technical Problem

The non-aqueous electrolyte of Patent Literature 1, however, tends to cause an excessive coating film to be formed on the negative electrode due to the inclusion of PS as an additive. Moreover, in the co-presence of PC, the decomposition of PC sometimes precedes the formation of a coating film due to the inclusion of PS, and the negative electrode may be deteriorated in association therewith.

The non-aqueous electrolytes of Patent Literatures 2 and 3 basically have a composition in which the amount of PC is small and the content of EC is large. As such, a coating film derived from EC tends to be formed excessively.

An excessive formation of a coating film can be a cause of deterioration in battery characteristics because the coating film also serves as a resistive component. For example, if a coating film is formed excessively, the intercalation and deintercalation of lithium ions are inhibited. As a result, the charge acceptance at the negative electrode is degraded, and Li is more likely to be deposited, causing the cycle characteristics of the non-aqueous electrolyte secondary battery to be deteriorated.

### Solution to Problem

One aspect of the present invention relates to a non-aqueous electrolyte including a non-aqueous solvent and a solute dissolved in the non-aqueous solvent. The non-aqueous solvent includes ethylene carbonate, propylene carbonate, diethyl carbonate, and a first additive. The weight percentage W_{PC} of the propylene carbonate relative to a total of the ethylene carbonate, propylene carbonate, and diethyl carbonate is 30 to 60% by weight, and the ratio W_{PC}/W_{EC} of the weight percentage W_{PC} of the propylene carbonate to the weight percentage W_{EC} of the ethylene carbonate relative to the total satisfies 2.25≦W_{PC}/W_{EC}≦6. The first additive comprises at least one of an unsaturated sultone and a sulfonic acid ester, and the weight percentage of the first additive in the whole non-aqueous electrolyte is 0.1 to 3% by weight.

According to the non-aqueous electrolyte of the present invention, it is possible to suppress gas generation in a non-aqueous electrolyte secondary battery during charge/discharge cycles in a high temperature environment.

Another aspect of the preset invention relates to a non-aqueous electrolyte secondary battery including a positive electrode, a negative electrode, a separator interposed between the positive electrode and the negative electrode, and the above-described non-aqueous electrolyte. The negative electrode includes a negative electrode core material and a negative electrode material mixture layer adhering to the negative electrode core material. The negative electrode material mixture layer includes graphite particles, a water-soluble polymer coated on the surfaces of the graphite particles, and a binder for bonding together the graphite particles coated with the water-soluble polymer.

The inclusion of a water-soluble polymer in the negative electrode material mixture layer allows easy penetration of The non-aqueous electrolyte including the first additive, into the negative electrode, and thus, even with a small amount of the first additive, a coating film tends to be uniformly formed. This can improve the charge acceptance at the negative electrode, as well as can favorably suppress gas generation during charge/discharge cycles in a high temperature environment.

More specifically, it relates to a non-aqueous electrolyte secondary battery including a positive electrode, a negative electrode, a separator interposed between the positive electrode and the negative electrode, and a non-aqueous electrolyte, wherein: the negative electrode includes a negative electrode core material and a negative electrode material mixture layer adhering to the negative electrode core material; the negative electrode material mixture layer includes graphite particles, a water-soluble polymer coated on the surfaces of the graphite particles, and a binder for bonding together the graphite particles coated with the water-soluble polymer; the non-aqueous electrolyte includes a non-aqueous solvent and a solute dissolved in the non-aqueous solvent; the non-aqueous solvent includes ethylene carbonate, propylene carbonate, diethyl carbonate, and a first additive; the weight percentage W_{PC} of the propylene carbonate relative to a total of the ethylene carbonate, propylene carbonate, and diethyl carbonate is 30 to 60% by weight; the ratio W_{PC}/W_{EC} of the weight percentage W_{PC} of the propylene carbonate to the weight percentage W_{PC} of the ethylene carbonate relative to the total satisfies 2.25≦W_{PC}/W_{EC}≦6; and the first additive comprises at least one of an unsaturated sultone and a sulfonic acid ester, and the weight percentage of the first additive in the whole non-aqueous electrolyte is 0.01 to 2.95% by weight.

### Advantageous Effects of Invention

It is possible to provide a non-aqueous electrolyte capable of suppressing gas generation in a non-aqueous electrolyte secondary battery during charge/discharge cycles in a high temperature environment, and a non-aqueous electrolyte secondary battery using the non-aqueous electrolyte.

While the novel features of the invention are set forth particularly in the appended claims, the invention, both as to organization and content, will be better understood and appreciated, along with other objects and features thereof, from the following detailed description taken in conjunction with the drawings.

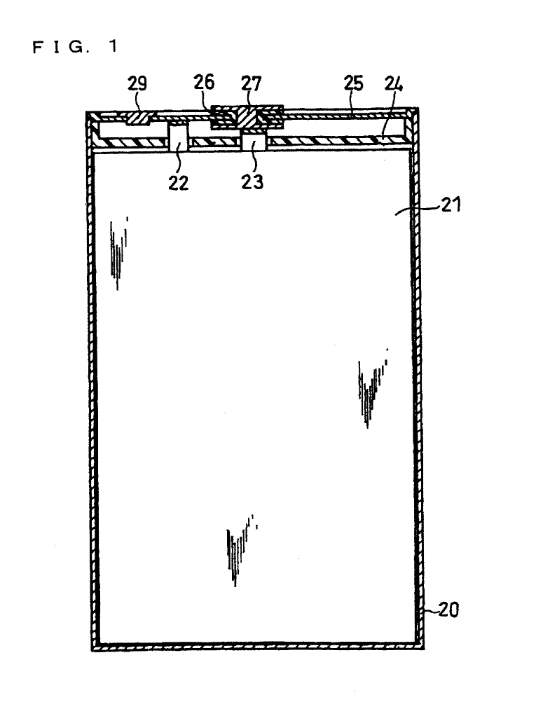

### BRIEF DESCRIPTION OF DRAWING

[FIG. 1] A longitudinal cross-sectional view schematically showing the configuration of a non-aqueous electrolyte secondary battery according to one embodiment of the present invention.

### DESCRIPTION OF EMBODIMENTS

A non-aqueous electrolyte includes a non-aqueous solvent and a solute dissolved in the non-aqueous solvent. In this embodiment, the non-aqueous solvent includes ethylene carbonate (EC), propylene carbonate (PC), diethyl carbonate (DEC), and a first additive. EC and PC have a high dielectric constant, which is advantageous in providing excellent lithium ion conductivity; however, because of their high viscosities, they need to be used in combination with DEC, whose viscosity is low.

The oxidation potentials of cyclic carbonates such as PC and EC are higher than those of chain carbonates such as DEC. As such, cyclic carbonates are less susceptible to oxidative decomposition than chain carbonates. On the other hand, chain carbonates are susceptible to reductive decomposition at the negative electrode. For this reason, if the weight percentage of DEC is relatively high, oxidative decomposition and reductive decomposition of DEC occur at the positive and negative electrodes, and the amount of generated gas such as CO, CO₂, CH₄, C₂H₆ is increased.

In contrast, if the weight percentage of EC is relatively high in a non-aqueous solvent including EC, PC and DEC, oxidative decomposition of EC occurs particularly at the positive electrode, and the amount of generated gas such as CO and CO₂ is increased. Further, if the weight percentage of EC is too high, an excessive amount of coating film is formed on the negative electrode. As a result, the charge acceptance is degraded, and Li is likely to be deposited.

In view of the above, in the present invention, the PC weight percentage W_{PC} relative to the total of EC, PC and DEC is set to be relatively high, specifically to 30 to 60% by weight. By setting the PC weight percentage W_{PC} to be relatively high, the oxidative decomposition and reductive decomposition of DEC and the oxidative decomposition of EC can be remarkably suppressed. The PC weight percentage W_{PC} is more preferably 40 to 60% by weight.

Further, the viscosity of the non-aqueous electrolyte can be lowered because PC (melting point: −49° C.) has a lower melting point than EC (melting point: 37° C.), and therefore, the use is advantageous in terms of low-temperature characteristics of the non-aqueous electrolyte secondary battery. In other words, by setting the PC weight percentage W_{PC} to be relatively high, the generation of gas derived from DEC and EC can be favorably suppressed, while the low-temperature characteristics of the non-aqueous electrolyte secondary battery can be improved.

In the non-aqueous solvent, the ratio W_{PC}/W_{EC} of the PC weight percentage W_{PC} to the EC weight percentage W_{EC} relative to the total of EC, PC and DEC satisfies 2.25≦W_{PC}/W_{EC}≦6.

When W_{PC}/W_{EC} is below 2.25, there is a possibility that the amount of gas generated by the oxidative decomposition of EC is increased particularly at the positive electrode. On the other hand, when W_{PC}/W_{EC} is over 6, there is a possibility that the amount of gas generated by the reductive decomposition of PC is increased particularly at the negative electrode. The ratio W_{PC}/W_{EC} of the PC weight percentage W_{PC} to the EC weight percentage W_{EC} more preferably satisfies 3≦W_{PC}/W_{EC}≦5.

It should be noted that, in addition to setting the weight percentage of PC in the non-aqueous solvent to be high, a first additive capable of inhibiting the reductive decomposition of PC is added to the non-aqueous electrolyte of the present invention. This makes it possible to suppress the generation of gas derived from EC and DEC and to improve the low-temperature characteristics of, the non-aqueous electrolyte secondary battery, as well as to suppress gas generation due to the reductive decomposition of PC.

The first additive comprises at least one of an unsaturated sultone and a sulfonic acid ester. These first additives are more preferentially reduced than PC at the negative electrode to form a coating film thereon, and therefore, can inhibit the reductive decomposition of PC. The decomposition potential of PC (vs. lithium) is about 0.9 V, while unsaturated sultones and sulfonic acid esters form a coating film at a potential as high as 1.2 to 1.25 V. Because of this, the coating film formation due to the first additive preferentially occurs, and hence the reductive decomposition of PC can be inhibited.

The weight percentage of the first additive in the whole non-aqueous electrolyte is 0.1 to 3% by weight. Unsaturated sultones and sulfonic acid esters each have a SO₃ group which is reductively active and has high reactivity. As such, even with a small amount as described above, an adequate amount of coating film can be formed stably on the negative electrode. This allows the impedance at the negative electrode to be kept small. When the amount of the first additive is below 0.1% by weight, a coating film is not formed sufficiently, failing to sufficiently inhibit the reductive decomposition of PC at the negative electrode. When the amount of the first additive is over 3% by weight, an excessive amount of coating film is formed on the negative electrode, and the charge acceptance is degraded, causing Li to be more likely to be deposited. The weight percentage of the first additive in the whole non-aqueous electrolyte is more preferably 0.5 to 1.5% by weight.

Typically, a saturated sultone (e.g., 1,3-propane sultone) is used as the first additive for forming a coating film on the negative electrode. However, the potential (vs. lithium) at which a saturated sultone forms a coating film is about 0.9 V. This potential is close to the decomposition potential of PC, and for this reason, the reductive decomposition of PC may not be sufficiently suppressed. Moreover, such a first additive is not reductively active and slightly low in reactivity, and therefore, is added in a comparatively large amount. As a result, a coating film tends to be formed excessively, causing the charge acceptance to be degraded.

When the non-aqueous solvent includes an unsaturated sultone, a coating film is formed on the positive and negative electrodes. The coating film formed on the positive electrode serves to suppress the oxidative decomposition of the non-aqueous solvent at the positive electrode in a high temperature environment. On the other hand, the coating film formed on the negative electrode serves to favorably suppress the reductive decomposition of the non-aqueous solvent, particularly, the reductive decomposition of PC, at the negative electrode.

The unsaturated sultone is preferably a compound represented by the following formula (1).

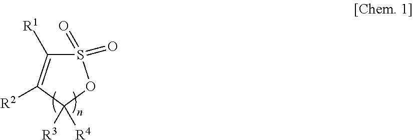

In the formula, n is an integer of 1 to 3; R¹ to R⁴ are independently a hydrogen atom, a fluorine atom, or an alkyl group; and at least one hydrogen atom in the alkyl group may be replaced with a fluorine atom.

Examples of the unsaturated sultone include 1,3-propene sultone, 2,4-butene sultone, 2,4-pentene sultone, 3,5-pentene sultone, 1-fluoro-1,3-propene sultone, 1,1,1-trifluoro-2,4-butene sultone, 1,4-butene sultone, and 1,5-pentene sultone. Among these, 1,3-propene sultone is more preferred because it is rich in polymerization reactivity. These unsaturated sultones may be used singly or in combination of two or more.

When the non-aqueous solvent includes a sulfonic acid ester, a coating film is formed on the negative electrode. The coating film formed on the negative electrode serves to suppress the reductive decomposition of the non-aqueous solvent, particularly, the reductive decomposition of PC, at the negative electrode.

The sulfonic acid ester is preferably a compound represented by the following formula (2).

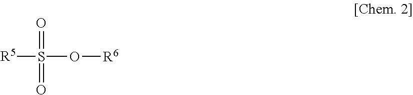

In the formula, R⁵ and R⁶ are independently an alkyl group or an aryl group; and at least one hydrogen atom in the alkyl group or the aryl group may be replaced with a fluorine atom.

A preferred sulfonic acid ester is an aromatic sulfonic acid ester in terms of its high potential at which it is reduced to form a coating film and its tendency to be preferentially reduced. Specifically, the sulfonic acid ester may be, for example, methyl benzenesulfonate, ethyl benzenesulfonate, trifluoromethyl benzenesulfonate, 2,2,2-trifluoroethyl benzenesulfonate, methyl 4-fluorobenzenesulfonate, ethyl 4-fluorobenzenesulfonate, methyl 3,5-difluorobenzenesulfonate, or methyl pentafluorobenzenesulfonate. Among these, methyl benzenesulfonate is particularly preferred because its coating film is low in resistance.

The first additive may comprise either one of an unsaturated sultone and a sulfonic acid ester, or may comprise both of them, but particularly preferably comprises an unsaturated sultone alone. In the case where the first additive comprises both an unsaturated sultone and a sulfonic acid ester, the amount of the unsaturated sultone may be 0.05 to 2% by weight of the whole non-aqueous electrolyte, and the amount of the sulfonic acid ester may be 0.05 to 1% by weight of the whole non-aqueous electrolyte.

The EC weight percentage W_{EC} relative to the total of EC, PC and DEC is preferably 5 to 20% by weight, and more preferably 10 to 15% by weight. When the weight percentage of EC is below 5% by weight, there is a possibility that a coating film (or a solid electrolyte interface (SEI)) is not formed sufficiently on the negative electrode, causing lithium ions to be less likely to be absorbed into or desorbed from the negative electrode. When the weight percentage of EC is over 20% by weight, there is a possibility that oxidative decomposition of EC occurs particularly at the positive electrode, and the amount of generated gas is increased. When the weight percentage of EC is over 20% by weight, there is a possibility that an excessive amount of coating film is formed on the negative electrode, and the charge acceptance is degraded, causing Li to be more likely to be deposited. With the weight percentage of EC in the non-aqueous solvent being 5 to 20% by weight, preferably 10 to 15% by weight, the amount of gas generated by the oxidative decomposition of EC is reduced, and an adequate amount of coating film is formed stably on the negative electrode, and as a result, the charge/discharge capacity and the rate characteristics of the non-aqueous electrolyte secondary battery are significantly improved.

The DEC weight percentage W_{DEC} relative to the total of EC, PC and DEC is preferably 30 to 65% by weight, and more preferably 35 to 55% by weight. When the weight percentage of DEC is below 30% by weight, there is a possibility that the discharge characteristics at low temperatures tend to be deteriorated. When the weight percentage of DEC is over 65% by weight, there is a possibility that the amount of generated gas is increased.

The ratio of the weight percentages EC, PC and DEC is preferably W_{EC}:W_{PC}:W_{DEC}=1:(3 to 6):(3 to 6), and more preferably 1:(3.5 to 5.5):(3.5 to 5.5), and particularly preferably 1:5:4. In a non-aqueous electrolyte having a ratio of the weight percentages of EC, PC and DEC within the foregoing range, the weight percentage of PC is large, and the weight percentages of EC and DEC is relatively small. As such, the amount of gas generated by the oxidation reaction or reduction reaction of EC and DEC can be significantly reduced.

In addition to the unsaturated sultone and sulfonic acid ester (the first additive) as described above, the non-aqueous electrolyte may further include another compound (a second additive) in view of improving the high-temperature cycle characteristics and low-temperature discharge characteristics. Examples of the second additive include, but not particularly limited to, cyclic sulfones such as sulfolane, fluorine-containing compounds such as fluorinated aromatic compounds and fluorinated ethers, cyclic carboxylic acid esters such as γ-butyrolactone, and fatty acid alkyl esters.

Among these, the second additive preferably comprises at least one of a fluorinated aromatic compound and a fatty acid alkyl ester. A fluorinated aromatic compound is, for example, a compound in which at least one hydrogen atom in benzene or toluene is replaced with a fluorine atom. The inclusion of the second additive reduces the viscosity of the non-aqueous electrolyte and improves the ion conductivity, and thus the polarization during charging and discharging is suppressed. As a result, the cycle characteristics and low-temperature discharge characteristics are improved. Further, the inclusion of the second additive suppresses a partial increase in the potential at the positive electrode and a Li deposition at the negative electrode, which suppresses the gas generation associated with charge/discharge cycles.

Examples of the fluorinated aromatic compound include fluorobenzene (FB), 1,2-difluorobenzene, 1,2,3-trifluorobenzene, 1,2,3,4-tetrafluorobenzene, pentafluorobenzene, hexafluorobenzene, 2-fluorotoluene, and trifluorotoluene. Among these, fluorobenzene (FB), 1,2-difluorobenzene and 1,2,3-trifluorobenzene are particularly preferred.

Examples of the fatty acid alkyl ester include ethyl propionate (EP), methyl pentanoate, ethyl pentanoate, methyl acetate, and ethyl acetate.

The weight percentage of the second additive in the whole non-aqueous electrolyte is preferably 10% by weight or less, more preferably 1 to 10% by weight, and particularly preferably 5 to 10% by weight.

With regard to the second additive, one type thereof may be used singly or two or more thereof may be used in combination.

The viscosity at 25° C. of the non-aqueous electrolyte is, for example, 3 to 7 mPa·s. By setting the viscosity within this range, it is possible to suppress the reduction in rate characteristics particularly at low temperatures. The viscosity of the non-aqueous electrolyte can be controlled by, for example, changing the weight percentage of a chain carbonate (e.g., DEC) in the non-aqueous electrolyte. The viscosity is measured with a rotational viscometer and a cone plate spindle.

Any solute for a non-aqueous electrolyte may be used without particular limitation. For example, an inorganic lithium fluoride such as LiPF₆ and LiBF₄, or a lithium imide compound such as LiN(CF₃SO₂)₂ and LiN(C₂F₅SO₂)₂ may be used.

By adding at least one of an unsaturated sultone and a sulfonic acid ester to a non-aqueous solvent in which the PC weight percentage W_{PC} relative to the total of EC, PC and DEC is 30 to 60% by weight, it is possible to provide a non-aqueous electrolyte that can stably and preferentially form an adequate amount of coating film on the negative electrode of the non-aqueous electrolyte secondary battery, and can suppress the gas generation during storage in a high temperature environment and during charge/discharge cycles. Further, by increasing the weight percentage of PC, the low-temperature characteristics of the non-aqueous electrolyte secondary battery are also improved.

The non-aqueous electrolyte secondary battery of the present invention is described below.

The non-aqueous electrolyte secondary battery includes a positive electrode, a negative electrode, a separator arranged between the positive electrode and the negative electrode, and the above-described non-aqueous electrolyte. Preferably, the non-aqueous electrolyte secondary battery is subjected to one charge/discharge operation prior to being used. The charge/discharge operation is preferably performed such that the potential at the negative electrode (vs. lithium) falls within the range of 0.08 to 1.4 V. By subjecting the battery to such charge/discharge operation, part of the first additive comprising at least one of an unsaturated sultone and a sulfonic acid ester is decomposed, forming a coating film on the positive electrode or negative electrode. The amount of the first additive in the non-aqueous electrolyte included in the battery having been subjected to the foregoing charge/discharge operation is, for example, 0.01 to 2.95% by weight.

In this embodiment, the negative electrode includes a negative electrode core material and a negative electrode material mixture layer adhering to the negative electrode core material, the negative electrode material mixture layer including graphite particles, a water-soluble polymer coated on the surfaces of the graphite particles, and a binder for bonding together the graphite particles coated with the water-soluble polymer.

Coating the surfaces of the graphite particles with a water-soluble polymer facilitates the penetration of the non-aqueous electrolyte including the first additive, into the negative electrode. This allows the non-aqueous electrolyte to be almost uniformly present on the surfaces of the graphite particles, which serves to easily form a negative electrode coating film uniformly without unevenness during initial charging. Therefore, even when the amount of the first additive to be added to the non-aqueous electrolyte is decreased, an adequate amount of coating film is stably formed on the negative electrode, and the reductive decomposition of PC can be favorably suppressed. For example, even when the amount of the first additive is as small as 0.5 to 1.5% by weight in the whole non-aqueous electrolyte before being injected into a battery (i.e., 0.01 to 1.45% by weight in the non-aqueous electrolyte included in a battery), the reductive decomposition of PC can be favorably suppressed. As a result, the charge acceptance at the negative electrode is improved, and the deposition of Li can be suppressed, while the gas generation can be suppressed. In short, the gas generation can be more significantly suppressed by using a water-soluble polymer in combination with the above-described non-aqueous electrolyte than by using either one of them alone.

Any kind of water-soluble polymer may be used without particular limitation, and for example, a cellulose derivative, a polyacrylic acid, a polyvinyl alcohol, or a polyvinylpyrrolidone, or a derivative of these may be used. Among these, particularly preferred is a water-soluble polymer comprising a cellulose derivative or a polyacrylic acid. Examples of the cellulose derivative include methyl cellulose, carboxymethyl cellulose, and Na salts of carboxymethyl cellulose. The molecular weight of the cellulose derivative is preferably from 10,000 to 1,000,000. The molecular weight of the polyacrylic acid is preferably from 5,000 to 1,000,000.

The amount of the water-soluble polymer in the negative electrode material mixture layer is preferably 0.4 to 2.8 parts by weight per 100 parts by weight of the graphite particles, more preferably 0.5 to 1.5 parts by weight, and particularly preferably 0.5 to 1 part by weight. When the amount of the water-soluble polymer is within the foregoing range, the water-soluble polymer can be coated on the surfaces of the graphite particles at a high coating rate. In addition, the surfaces of the graphite particles are not excessively coated with the water-soluble polymer, and thus the increase in internal resistance of the negative electrode is suppressed.

The binder to be contained in the negative electrode material mixture layer is not particularly limited, but is preferably a particulate binder with rubber elasticity. The average particle diameter of the particulate binder is preferably 0.1 μm to 0.3 μm, and more preferably 0.1 to 0.26 μm, particularly preferably 0.1 to 0.15 μm, and most preferably 0.1 to 0.12 μm. The average particle diameter of the binder is determined, for example, based on SEM photographs of ten binder particles obtained by using a transmission electron microscope (available from JEOL Ltd., acceleration voltage 200 kV), as an average of the maximum diameters of these ten binder particles.

A particularly preferable particulate binder with rubber elasticity having an average particle diameter of 0.1 μm to 0.3 μm is a polymer having styrene units and butadiene units. Such a polymer is highly elastic and is stable at a negative electrode potential.

The amount of the binder in the negative electrode material mixture layer is preferably 0.4 to 1.5 parts by weight per 100 parts by weight of the graphite particles, more preferably 0.4 to 1 part by weight, and particularly preferably 0.4 to 0.7 part by weight. When the surfaces of the graphite particles are coated with a water-soluble polymer, the slidability between the graphite particles is good. As such, the binder adhering to the surfaces of the graphite particles coated with the water-soluble polymer is subjected to sufficient shear force and effectively acts on the surfaces of the graphite particles. Further, when the binder is particulate and small in average particle diameter, the probability that the binder comes in contact with the surfaces of the graphite particles coated with the water-soluble polymer is increased. As such, the binder, even when the amount thereof is small, can exhibit sufficient binding ability.

For the negative electrode core material, for example, a metallic foil is used. In producing a negative electrode for lithium ion secondary batteries, for example, copper foil or copper alloy foil is typically used as the negative electrode core material. Among these, copper foil (which may contain a component(s) other than copper in an amount of 0.2 mol% or less) is preferred, and electrolytic copper foil is particularly preferred.

The penetration rate of water into the negative electrode material mixture layer is preferably from 3 to 40 seconds. The penetration rate of water into the negative electrode material mixture layer can be controlled by, for example, the coating amount of the water-soluble polymer. When the penetration rate of water into the negative electrode material mixture layer is from 3 to 40 seconds, the non-aqueous electrolyte including the first additive is very likely to penetrate into the negative electrode. This can more favorably suppress the reductive decomposition of PC. The penetration rate of water into the negative electrode material mixture layer is more preferably from 10 to 25 seconds.

The penetration rate of water into the negative electrode material mixture layer can be measured in an environment of 25° C. by, for example, the method as described below.

First, 2 μL of water is dropped, to allow a water droplet to be in contact with the surface of the negative electrode material mixture layer. Then, the time period until the contact angle θ of water with respect to the surface of the negative electrode material mixture layer is reduced to be less than 10° is measured to determine a penetration rate of water into the negative electrode material mixture layer. The contact angle of water with respect to the surface of the negative electrode material mixture layer may be measured with a commercially available contact angle meter (e.g., DM-301 available from Kyowa Interface Science Co., Ltd.).

The porosity of the negative electrode material mixture layer is preferably 24 to 28%. By controlling the porosity of the negative electrode material mixture layer including graphite particles whose surfaces are coated with a water-soluble polymer within the range from 24 to 28%, the penetration of the non-aqueous electrolyte including the first additive into the negative electrode is facilitated. As a result, a coating film is more likely to be uniformly formed on the negative electrode, which can more favorably inhibit the reductive decomposition of PC.

The negative electrode includes graphite particles as a negative electrode active material. The graphite particles as used herein are particles including a region having a graphite structure. Accordingly, the graphite particles include natural graphite particles, artificial graphite particles, graphitized mesophase carbon particles, and the like.

Diffraction patterns of the graphite particles measured by a wide-angle X-ray diffractometry have a peak attributed to the (101) plane and a peak attributed to the (100) plane. Here, the ratio of a peak intensity I(101) attributed to the (101) plane to a peak intensity I(100) attributed to the (100) plane preferably satisfies 0.01<I(101)/I(100)<0.25, and more preferably satisfies 0.08<I(101)/I(100)<0.2. The peak intensity means the height of a peak.

The average particle diameter of the graphite particles is preferably 14 to 25 μm, and more preferably 16 to 23 μm. The average particle diameter within the foregoing range improves the slidability of the graphite particles in the negative electrode material mixture layer, allows the graphite particles to be packed in a favorable state, and is advantageous in enhancing the adhesion strength between the graphite particles. The average particle diameter means a median diameter (D50) in a volumetric particle size distribution of the graphite particles. The volumetric particle size distribution of the graphite particles can be measured with, for example, a commercially available laser diffraction-type particle size distribution analyzer.

The average circularity of the graphite particles is preferably from 0.9 to 0.95, and more preferably from 0.91 to 0.94. The average circularity within the foregoing range improves the slidability of the graphite particles in the negative electrode material mixture layer, and is advantageous in improving the packability of the graphite particles and enhancing the adhesion strength between the graphite particles. The average circularity is represented by 4 πS/L², where S is an area of an orthographic projection image of the graphite particle, and L is a circumferential length of the orthographic projection image. For example, it is preferable that the average circularity of arbitrarily selected 100 graphite particles is within the foregoing range.

The specific surface area S of the graphite particles is preferably 3 to 5 m²/g, and more preferably 3.5 to 4.5 m²/g. The specific surface area within the foregoing range improves the slidability of the graphite particles in the negative electrode material mixture layer, and is advantageous in enhancing the adhesion strength between the graphite particles. In addition, the preferred amount of the water-soluble polymer required for coating the surfaces of the graphite particles can be reduced.

In order to coat the surfaces of the graphite particles with a water-soluble polymer, it is desirable to produce a negative electrode in the production method as described below. Methods A and B are described here as exemplary production methods.

The method A is described first.

The method A includes a step of mixing graphite particles, water, and a water-soluble polymer dissolved in water, and drying the resultant mixture, to give a dry mixture (step (i)). For example, a water-soluble polymer is dissolved in water, to prepare an aqueous solution of the water-soluble polymer. The obtained aqueous solution of the water-soluble polymer is mixed with graphite particles, and then, the water is removed therefrom to dry the mixture. By preliminarily drying the mixture as above, the water-soluble polymer is allowed to efficiently adhere to the surfaces of the graphite particles, and the surfaces of the graphite particles are coated with the water-soluble polymer at a higher coating rate.

The viscosity at 25° C. of the aqueous solution of the water-soluble polymer is preferably controlled to 1000 to 10000 mPa·s. The viscosity is measured with a B-type viscometer at a circumferential velocity of 20 mm/s using a 5-mm-diameter spindle. The amount of the graphite particles to be mixed with 100 parts by weight of the aqueous solution of the water-soluble polymer is preferably 50 to 150 parts by weight.

The drying temperature of the mixture is preferably from 80 to 150° C., and the drying time thereof is preferably from 1 to 8 hours.

Subsequently, the obtained dry mixture is mixed with a binder and a liquid component, to prepare a negative electrode material mixture slurry (step (ii)). By performing this step, the binder is allowed to adhere to the surfaces of the graphite particles coated with the water-soluble polymer. Since the slidability between the graphite particles is good, the binder adhering to the surfaces of the graphite particles coated with the water-soluble polymer is subjected to sufficient shear force and effectively acts on the surfaces of the graphite particles coated with the water-soluble polymer.

The obtained negative electrode material mixture slurry is applied onto a negative electrode core material and dried, to form a negative electrode material mixture layer, whereby a negative electrode is obtained (step (iii)). The method of applying the negative electrode material mixture slurry onto the negative electrode core material is not particularly limited. For example, the negative electrode material mixture slurry is applied at a predetermined pattern onto a raw sheet of the negative electrode core material with a die coater. The drying temperature of the applied film is also not particularly limited. The applied film after drying is rolled with press rolls, to have a predetermined thickness. As a result of the rolling, the adhesion strength between the negative electrode material mixture layer and the negative electrode core material and the adhesion strength between the graphite particles coated with the water-soluble polymer are enhanced. The negative electrode material mixture layer thus obtained is cut together with the negative electrode core material into a predetermined shape, whereby a negative electrode is completed.

Secondly, the method B is described.

The method B includes a step of mixing graphite particles, a binder, water, and a water-soluble polymer dissolved in water, and drying the resultant mixture, to give a dry mixture (step (i)). For example, a water-soluble polymer is dissolved in water, to prepare an aqueous solution of the water-soluble polymer. The viscosity of the aqueous solution of the water-soluble polymer may be the same as that in the method A. The obtained aqueous solution of the water-soluble polymer is mixed with a binder and graphite particles, and then, the water is removed therefrom to dry the mixture. By preliminarily drying the mixture as above, the water-soluble polymer and the binder are allowed to efficiently adhere to the surfaces of the graphite particles. As such, the surfaces of the graphite particles are coated with the water-soluble polymer at a higher coating rate, and the binder is allowed to adhere in a favorable state to the surfaces of the graphite particles coated with the water-soluble polymer. In view of improving the dispersibility of the binder into the aqueous solution of the water-soluble polymer, it is preferable to mix the binder in the form of emulsion in which the dispersion medium is water, with the aqueous solution of the water-soluble polymer.

Subsequently, the obtained dry mixture is mixed with a liquid component, to prepare a negative electrode material mixture slurry (step (ii)). By performing this step, the graphite particles coated with the water-soluble polymer and the binder swell to some extent with the liquid component, and the slidability between the graphite particles becomes good.

The obtained negative electrode material mixture slurry is applied onto a negative electrode core material, dried, rolled and formed into a negative electrode material mixture layer in the same manner as in the method A, whereby a negative electrode is obtained (step (iii)).

The liquid component to be used in preparing the negative electrode material mixture slurry in the methods A and B is not particularly limited, but is preferably, for example, water or an aqueous alcohol solution, among which water is most preferred. N-methyl-2-pyrrolidone (hereinafter “NMP”) or the like may also be used.

For the positive electrode, any positive electrode may be used without any particular limitation, as long as it can be used as a positive electrode for non-aqueous electrolyte secondary batteries. The positive electrode is obtained by, for example, applying a positive electrode material mixture slurry including a positive electrode active material, a conductive agent such as carbon black, and a binder such as polyvinylidene fluoride onto a positive electrode core material such as aluminum foil, followed by drying and rolling. A preferred positive electrode active material is a lithium-containing transition metal composite oxide. Typical examples of the lithium-containing transition metal composite oxide include LiCoO₂, LiNiO₂, LiMn₂O₄, LiMnO₂, and LiₓNi_{y}M_{z}Me_{1-(y+1)}O_{2+d}.

Above all, the positive electrode preferably includes a composite oxide containing lithium and nickel, in view of achieving a high capacity as well as more effectively suppressing the gas generation. In this case, the molar ratio of nickel to lithium in the composite oxide is preferably 30 to 100 mol %.

Preferably, the composite oxide further contains at least one selected from the group consisting of manganese and cobalt, and the molar ratio of the total of manganese and cobalt to lithium is preferably 70 mol % or less.

Preferably, the composite oxide furthermore contains element M other than Li, Ni, Mn, Co and 0, and the molar ratio of element M to lithium is preferably 1 to 10 mol %.

An example of the lithium-nickel-containing composite oxide is represented by, for example, the general formula (1):

LiₓNi_{y}M_{z}Me_{1-(y+z)}O_{2+d} (1),

where M is at least one element selected from the group consisting of Co and Mn; Me is at least one element selected from the group consisting of Al, Cr, Fe, Mg and Zn; 0.98≦x≦1.1; 0.3≦y≦1; 0≦z≦0.7; 0.9≦(y+z)≦1; and −0.01≦d≦0.01.

For the separator, a microporous film made of polyethylene, polypropylene or the like is typically used. The thickness of the separator is, for example, 10 to 30 μm.

The present invention is applicable to non-aqueous electrolyte secondary batteries of various shapes, such as batteries of cylindrical shape, flat shape, coin shape, and prismatic shape, without any particular limitation to the shape of the battery.

The present invention is specifically described below with reference to examples and comparative examples. It should be noted, however, the present invention is not limited to the following examples.

### EXAMPLES

### Example 1

(a) Production of Negative Electrode

Step (i)

First, carboxymethyl cellulose (hereinafter “CMC”, molecular weight: 400,000) being a water-soluble polymer was dissolved in water, to prepare an aqueous solution in which the CMC concentration was 1% by weight. Subsequently, 100 parts by weight of natural graphite particles (average particle diameter: 20 μm, average circularity: 0.92, specific surface area: 4.2 m²/g) and 100 parts by weight of the CMC aqueous solution were mixed together, and stirred while the temperature of the mixture was controlled at 25° C. Thereafter, the mixture was dried at 120° C. for 5 hours, to give a dry mixture. In the dry mixture, the amount of CMC per 100 parts by weight of the graphite particles was 1 part by weight.

Step (ii)

The obtained dry mixture was mixed in an amount of 101 parts by weight with 0.6 parts by weight of a particulate binder with rubber elasticity having an average particle diameter of 0.12 μm and having styrene units and butadiene units (hereinafter “SBR”), 0.9 parts by weight of carboxymethyl cellulose, and an appropriate amount of water, to prepare a negative electrode material mixture slurry. Here, in mixing SBR with the other components, the SBR was in the form of emulsion in which the dispersion medium was water (BM-400B (trade name) available from Zeon Corporation, Japan, weight percentage of SBR: 40 wt %).

Step (iii)

The prepared negative electrode material mixture slurry was applied onto both surfaces of an electrolytic copper foil (thickness: 12 μm) serving as the negative electrode core material with a die coater, and the applied film was dried at 120° C. Thereafter, the dried applied film was rolled between press rollers at a line pressure of 0.25 ton/cm, to form a negative electrode material mixture layer having a thickness of 160 μm and having a graphite density of 1.65 g/cm³. The negative electrode material mixture layer was cut together with the negative electrode core material into a predetermined shape, to produce a negative electrode.

The penetration rate of water into the negative electrode material mixture layer was measured in the manner as described below.

First, 2 μL of water was dropped, to allow a water droplet to be in contact with the surface of the negative electrode material mixture layer. Then, the time period until the contact angle θ of water at 25° C. with respect to the surface of the negative electrode material mixture layer was reduced to be less than 10° was measured with a contact angle meter (DM-301 available from Kyowa Interface Science Co., Ltd.). The measured penetration rate of water into the negative electrode material mixture layer was 15 seconds.

In addition, the porosity of the negative electrode material mixture layer calculated from the true density of each material constituting the negative electrode material mixture was 25%.

### (b) Production of Positive Electrode

To 100 parts by weight of LiNi_{0.80}Co_{0.15}Al_{0.05}O₂ serving as the positive electrode active material, 4 parts by weight of polyvinylidene fluoride (PVDF) serving as the binder was added, and mixed with an appropriate amount of N-methyl-2-pyrrolidone (NMP), to prepare a positive electrode material mixture slurry. The prepared positive electrode material mixture slurry was applied onto both surfaces of a 20-μm-thick aluminum foil serving as the positive electrode core material by using a die coater, and the applied film was dried and then rolled, whereby a positive electrode material mixture layer was formed. The positive electrode material mixture layer was cut together with the positive electrode core material into a predetermined shape, to produce a positive electrode.

(c) Preparation of Non-Aqueous Electrolyte

LiPF₆ was dissolved at a concentration of 1 mol/liter in a mixed solvent containing ethylene carbonate (EC), propylene carbonate (PC), and diethyl carbonate (DEC) at a weight ratio of 10:50:40, to prepare a non-aqueous electrolyte. To the non-aqueous electrolyte, 1% by weight of 1,3-propene sultone (PRS) was added as the first additive. The viscosity at 25° C. of the non-aqueous electrolyte measured with a rotational viscometer (cone-plate type, diameter of cone plate: 24 mm) was 5.4 mPa·s.

(d) Fabrication of Battery

A prismatic lithium ion secondary battery as shown in FIG. 1 was fabricated.

The negative electrode and the positive electrode were wound with a separator of a polyethylene microporous film having a thickness of 20 μm (A089 (trade name) available from Celgard, LLC.) interposed therebetween, to form an electrode assembly 21 having an approximate elliptic cross section. The electrode assembly 21 was encased in a prismatic battery can 20 made of aluminum. The battery can 20 had a bottom and a side wall, and has an approximate square opening at the top. The main flat portion of the side wall was 80 μm in thickness. Then, an insulator 24 for preventing short circuit between the battery can 20 and a positive electrode lead 22 or a negative electrode lead 23 was disposed on top of the electrode assembly 21. Next, a square sealing plate 25 having at its center a negative electrode terminal 27 surrounded by an insulating gasket 26 was arranged at the opening of the battery can 20. The negative electrode lead 23 was connected to the negative electrode terminal 27. The positive electrode lead 22 was connected to the lower surface of the sealing plate 25. The edge of the opening and the sealing plate 25 were welded together by a laser, to seal the opening of the battery can 20. Subsequently, 2.5 g of the non-aqueous electrolyte was injected into the battery can 20 through an injection hole of the sealing plate 25. Finally, the injection hole was closed with a sealing stopper 29 and sealed by welding, to complete a prismatic lithium ion secondary battery 1 having a height of 50 mm and a width of 34 mm, including an internal space of about 5.2 mm in thickness, and having a design capacity of 850 mAh.

<Evaluation of Battery>

### (1) Evaluation of Cycle Capacity Retention Rate

The battery 1 was subjected to repeated charge/discharge cycles at 45° C. In each charge/discharge cycle, charging was performed as follows: first, a constant current charge was performed at a charge current of 600 mA with a cut-off voltage of 4.2 V, and then, a constant voltage charge was performed at 4.2 V until the current reached an end-of-charge current of 43 mA. The battery was allowed to stand after charging for 10 minutes. In discharging, a constant current discharge was performed at a discharge current of 850 mA with a discharge cut-off voltage of 2.5 V. The battery was allowed to stand after discharging for 10 minutes.

Assuming that the discharge capacity at the 3rd cycle was 100%, the discharge capacity after 500 cycles was expressed as a cycle capacity retention rate [%]. The result is shown in Table 1.

### (2) Evaluation of Battery Swelling

The thicknesses of the center portion of the battery 1 perpendicular to the largest plane thereof (longitudinal length: 50 mm, lateral length: 34 mm) in the state after charging at the 3rd cycle and in the state after charging at the 501th cycle were measured. The difference between the measured battery thicknesses was calculated as a battery swelling amount [mm] after charge/discharge cycles at 45° C. The result is shown in Table 1.

### (3) Low-Temperature Discharge Characteristic Evaluation

The battery 1 was subjected to three charge/discharge cycles at 25° C. In the 4th cycle, the battery was charged at 25° C., then allowed to stand for 3 hours at 0° C., and discharged at 0° C. Assuming that the discharge capacity at the 3rd cycle (at 25° C.) was 100%, the percentage of the discharge capacity at the 4th cycle (at 0° C.) was expressed as a percentage, which was defined as a low-temperature discharge capacity retention rate [%]. The result is shown in Table 1. Here, the conditions for charging and discharging were the same as those in (i), except for the length of time during which the battery was allowed to stand after charging.

### Example 2

Non-aqueous electrolytes were prepared in the same manner as in Example 1, except that the amount of the first additive was changed as shown in Table 1. Batteries 2 to 9 were fabricated in the same manner as in Example 1, except that the obtained non-aqueous electrolytes were used. It should be noted that the batteries 2, 3 and 9 are of Comparative Example.

The batteries 2 to 9 were evaluated in the same manner as in Example 1. The results are shown in Table 1.

TABLE 1

| | | Cycle | Battery | Low-temperature |
|---|---|---|---|---|
| | | capacity | swelling | discharge |
| | Amount of | retention | after | capacity |
| | additive | rate | cycling | retention |
| | (wt %) | (%) | (mm) | rate (%) |
| Battery 1 | 1 | 86.8 | 0.29 | 75.0 |
| Battery 2 | 0 | Charge/ | — | — |
| (Com. Ex.) | | discharge | | |
| | | impossible | | |
| Battery 3 | 0.05 | 54.5 | 1.03 | 63.9 |
| (Com. Ex.) | | | | |
| Battery 4 | 0.1 | 80.2 | 0.57 | 74.6 |
| Battery 5 | 0.5 | 85.4 | 0.32 | 74.8 |
| Battery 6 | 1.5 | 86.2 | 0.31 | 73.5 |
| Battery 7 | 2 | 84.1 | 0.37 | 72.0 |
| Battery 8 | 3 | 82.9 | 0.44 | 71.2 |
| Battery 9 | 4 | 67.3 | 0.85 | 55.8 |
| (Com. Ex.) | | | | |

From Table 1, the batteries which use a non-aqueous electrolyte including the first additive in an amount of 0.1 to 3% by weight were excellent in the cycle capacity retention rate and the low-temperature discharge capacity retention rate. In addition, the battery swelling after cycling was small, indicating that the amount of generated gas was small. Among these, the batteries 1, 5 and 6 including the first additive in an amount of 0.5 to 1.5% by weight were more excellent in the cycle capacity retention rate and the low-temperature discharge capacity retention rate. In addition, the battery swelling was smaller. The foregoing results show that the inclusion of an unsaturated sultone as the first additive in a non-aqueous electrolyte containing EC, PC and DEC can favorably suppress gas generation.

When the non-aqueous electrolyte included no first additive, charging and discharging were impossible. When the amount of the first additive was below 0.1% by weight, the cycle characteristics and the low-temperature discharge capacity retention rate were both reduced. This is presumably because a coating film was not sufficiently formed on the negative electrode due to the inclusion of a small amount of the first additive, failing to sufficiently suppress the reductive decomposition of PC. When the amount of the first additive was over 3% by weight also, the cycle characteristics and the low-temperature discharge capacity retention rate were both reduced. This is presumably because an excessive coating film was formed on the negative electrode, causing the charge acceptance to be degraded.

### Example 3

Non-aqueous electrolytes were prepared in the same manner as in Example 1, except that the ratio of the weight percentages of ethylene carbonate (EC), propylene carbonate (PC) and diethyl carbonate (DEC) was changed as shown in Table 2. Batteries 10 to 17 were fabricated in the same manner as in Example 1, except that the obtained non-aqueous electrolytes were used. It should be noted that the batteries 10 and 17 are of Comparative Example.

The batteries 10 to 17 were evaluated in the same manner as in Example 1. The results are shown in Table 2.

TABLE 2

| | | | Cycle | Battery | Low-temperature |
|---|---|---|---|---|---|
| | | | capacity | swelling | discharge |
| | | | retention | after | capacity |
| | | Viscosity | rate | cycling | retention |
| | W_{EC}:W_{PC}:W_{DEC} | (mPa · s) | (%) | (mm) | rate (%) |
| Battery 10 | 10:20:70 | 4.0 | 55.5 | 1.08 | 75.4 |
| (Com. Ex.) | | | | | |
| Battery 11 | 10:30:60 | 4.5 | 80.5 | 0.57 | 75.2 |
| Battery 12 | 10:40:50 | 5.0 | 86.3 | 0.31 | 75.2 |
| Battery 1 | 10:50:40 | 5.4 | 86.8 | 0.29 | 75.0 |
| Battery 13 | 10:60:30 | 5.9 | 84.1 | 0.42 | 71.3 |
| Battery 14 | 5:30:65 | 4.2 | 81.7 | 0.50 | 72.0 |
| Battery 15 | 15:35:50 | 4.9 | 83.0 | 0.45 | 75.1 |
| Battery 16 | 20:45:35 | 5.6 | 80.9 | 0.58 | 71.5 |
| Battery 17 | 10:70:20 | 6.7 | 68.4 | 0.88 | 66.9 |
| (Com. Ex.) | | | | | |

From Table 2, the batteries using a non-aqueous electrolyte in which the PC weight percentage W_{PC} was 30 to 60% by weight and the ratio W_{PC}/W_{EC} of the PC weight percentage W_{PC} to the EC weight percentage W_{EC} satisfied 2.25≦W_{PC}/W_{EC}≦6 were excellent in the cycle capacity retention rate and the low-temperature discharge capacity retention rate. In addition, the battery swelling after cycling was small. Among these, the battery 12 was more excellent in the cycle capacity retention rate and the low-temperature discharge capacity retention rate, and the battery swelling was smaller.

When W_{PC} was below 30% by weight, the battery swelling after cycling at high temperatures was increased, and the cycle capacity retention rate was reduced. The non-aqueous solvent of this battery contained relatively large amounts of DEC and EC. This presumably resulted in an increased amount of gas generated by the oxidative decomposition and reductive decomposition of DEC at the positive and negative electrodes and the oxidative decomposition of EC at the positive electrode. When W_{PC} was over 60% by weight also, the battery swelling after cycling at high temperatures was increased, and the cycle capacity retention rate was reduced. This is presumably resulted from the reductive decomposition of PC at the negative electrode due to the inclusion of an excessive amount of PC.

### Example 4

Non-aqueous electrolytes were prepared in the same manner as in Example 1, except that methyl benzenesulfonate was added as the first additive in an amount as shown in Table 3, in place of 1,3-propene sultone. Batteries 18 to 25 were fabricated in the same manner as in Example 1, except that the obtained non-aqueous electrolytes were used. It should be noted that the batteries 18 and 25 are of Comparative Example.

The batteries 18 to 25 were evaluated in the same manner as in Example 1. The results are shown in Table 3.

TABLE 3

| | | Cycle | Battery | Low-temperature |
|---|---|---|---|---|
| | | capacity | swelling | discharge |
| | Amount of | retention | after | capacity |
| | additive | rate | cycling | retention |
| | (wt %) | (%) | (mm) | rate (%) |
| Battery 2 | 0 | Charge/ | — | — |
| (Com. Ex.) | | discharge | | |
| | | impossible | | |
| Battery 18 | 0.05 | 50.3 | 1.12 | 62.4 |
| (Com. Ex.) | | | | |
| Battery 19 | 0.1 | 80.0 | 0.59 | 74.5 |
| Battery 20 | 0.5 | 85.0 | 0.35 | 74.6 |
| Battery 21 | 1 | 86.1 | 0.32 | 74.8 |
| Battery 22 | 1.5 | 85.3 | 0.34 | 73.1 |
| Battery 23 | 2 | 83.2 | 0.39 | 71.7 |
| Battery 24 | 3 | 80.8 | 0.50 | 71.0 |
| Battery 25 | 4 | 54.3 | 0.92 | 43.8 |
| (Com. Ex.) | | | | |

From Table 3, the batteries using a non-aqueous electrolyte including methyl benzenesulfonate as the first additive in an amount of 0.1 to 3% by weight were excellent in the cycle capacity retention rate and the low-temperature discharge capacity retention rate. In addition, the battery swelling after cycling was small, indicating that the amount of generated gas was small. Among these, the batteries 20 to 22 including the first additive in an amount of 0.5 to 1.5% by weight were more excellent in the cycle capacity retention rate and the low-temperature discharge capacity retention rate. In addition, the battery swelling was much smaller. The foregoing results show that the inclusion of a sulfonic acid ester as the first additive in a non-aqueous electrolyte containing EC, PC and DEC also can favorably suppress gas generation as in the case of the inclusion of an unsaturated sultone.

### Example 5

Non-aqueous electrolytes were prepared in the same manner as in the battery 21 of Example 4, except that the ratio of the weight percentages of ethylene carbonate (EC), propylene carbonate (PC) and diethyl carbonate (DEC) was changed as shown in Table 4. Batteries 26 to 32 were fabricated in the same manner as in the battery 21 of Example 4, except that the obtained non-aqueous electrolytes were used. It should be noted that the battery 26 is of Comparative Example.

The batteries 26 to 32 were evaluated in the same manner as in Example 1. The results are shown in Table 4.

TABLE 4

| | | | Cycle | Battery | Low-temperature |
|---|---|---|---|---|---|
| | | | capacity | swelling | discharge |
| | | | retention | after | capacity |
| | | Viscosity | rate | cycling | retention |
| | W_{EC}:W_{PC}:W_{DEC} | (mPa · s) | (%) | (mm) | rate (%) |
| Battery 26 | 10:20:70 | 4.0 | 52.0 | 1.13 | 74.7 |
| (Com. Ex.) | | | | | |
| Battery 27 | 10:30:60 | 4.5 | 80.1 | 0.58 | 74.6 |
| Battery 28 | 10:40:50 | 5.0 | 85.7 | 0.33 | 74.7 |
| Battery 21 | 10:50:40 | 5.4 | 86.1 | 0.32 | 74.8 |
| Battery 29 | 10:60:30 | 5.9 | 83.4 | 0.46 | 71.0 |
| Battery 30 | 5:30:65 | 4.2 | 80.9 | 0.51 | 71.5 |
| Battery 31 | 15:35:50 | 4.9 | 82.2 | 0.49 | 74.3 |
| Battery 32 | 20:45:35 | 5.6 | 80.5 | 0.59 | 70.7 |

From Table 4, the batteries using a non-aqueous electrolyte in which the PC weight percentage W_{PC} was 30 to 60% by weight and the ratio W_{PC}/W_{PC} of the PC weight percentage W_{PC} to the EC weight percentage W_{EC} satisfied 2.25≦W_{PC}/W_{EC}≦6 were excellent in the cycle capacity retention rate and the low-temperature discharge capacity retention rate, even when the non-aqueous electrolyte included methyl benzenesulfonate as the first additive. In addition, the battery swelling after cycling was small. Among these, the batteries 21, 28 and 29 were more excellent in the cycle capacity retention rate.

### Example 6

Negative electrodes were produced in the same manner as in Example 1, except that the amount of CMC per 100 parts by weight of graphite particles in the dry mixture and the penetration rate of water into the negative electrode material mixture layer were changed as shown in Table 5. The amount of CMC per 100 parts by weight of graphite particles was changed by changing the concentration of CMC in the CMC aqueous solution. Batteries 33 to 40 were fabricated in the same manner as in Example 1, except that the obtained negative electrodes were used.

The batteries 33 to 40 were evaluated in the same manner as in Example 1. The results are shown in Table 5.

TABLE 5

| | | Penetration rate | Cycle | Battery | Low-temperature |
|---|---|---|---|---|---|
| | | of water into | capacity | swelling | discharge |
| | Amount of | negative electrode | retention | after | capacity |
| | CMC | material mixture | rate | cycling | retention |
| | (wt %) | layer (sec) | (%) | (mm) | rate (%) |
| Battery 33 | 0.2 | 3 | 80.0 | 0.59 | 70.9 |
| Battery 34 | 0.4 | 5 | 82.7 | 0.47 | 74.8 |
| Battery 35 | 0.7 | 10 | 85.4 | 0.34 | 75.0 |
| Battery 1 | 1.0 | 15 | 86.8 | 0.29 | 75.0 |
| Battery 36 | 1.2 | 20 | 85.1 | 0.35 | 73.7 |
| Battery 37 | 1.5 | 25 | 84.1 | 0.39 | 73.2 |
| Battery 38 | 2.0 | 30 | 82.0 | 0.45 | 72.6 |
| Battery 39 | 2.8 | 40 | 80.3 | 0.58 | 71.0 |
| Battery 40 | 3.7 | 50 | 71.2 | 0.75 | 66.4 |

From Table 5, the batteries in which the amount of CMC in the negative electrode material mixture layer was 0.4 to 2.8 parts by weight per 100 parts by weight of graphite particles were excellent in the cycle capacity retention rate and the low-temperature discharge capacity retention rate. In addition, the battery swelling after cycling was small. Among these, the batteries 35 to 37 in which the amount of CMC was 0.5 to 1.5 parts by weight were more excellent in the cycle capacity retention rate and the low-temperature discharge capacity retention rate, and the battery swelling was much smaller. This is presumably because the penetration of the non-aqueous electrolyte including the first additive into the negative electrode was facilitated by coating the surfaces of the graphite particles with water-soluble polymer, and thus a coating film was formed uniformly without unevenness.

### Example 7

Negative electrodes were produced in the same manner as in Example 1, except that water-soluble polymers as shown in Table 6 were used. Batteries 41 to 44 were fabricated in the same manner as in Example 1, except that the obtained negative electrodes were used. The molecular weight of the water-soluble polymers used here was 1,000,000. It should be noted that the battery 41 containing no water-soluble polymer is of Comparative Example.

The batteries 41 to 44 were evaluated in the same manner as in Example 1. The results are shown in Table 6.

TABLE 6

| | | Cycle | Battery | Low-temperature |
|---|---|---|---|---|
| | | capacity | swelling | discharge |
| | | retention | after | capacity |
| | Water-soluble | rate | cycling | retention |
| | polymer | (%) | (mm) | rate (%) |
| Battery 41 | Not contained | 80.1 | 0.59 | 70.3 |
| (Com. Ex.) | | | | |
| Battery 1 | CMC | 86.8 | 0.29 | 75.0 |
| Battery 42 | Na salt of CMC | 83.3 | 0.45 | 73.3 |
| Battery 43 | Methyl cellulose | 82.0 | 0.44 | 72.9 |
| Battery 44 | Polyacrylic acid | 86.7 | 0.29 | 75.1 |

From Table 6, the batteries including the negative electrode material mixture layer containing a water-soluble polymer were excellent in the cycle capacity retention rate and the low-temperature discharge capacity retention rate, and the battery swelling was small. On the other hand, in the battery 41 including the negative electrode material mixture layer containing no water-soluble polymer, the battery swelling was large after cycling. The results show that a water-soluble polymer other than CMC can be used with similar effects to those of CMC.

### Example 8

Non-aqueous electrolytes were prepared in the same manner as in Example 1, except that fluorobenzene (FB) was added as the second additive in an amount as shown in Table 7. Batteries 45 to 48 were fabricated in the same manner as in Example 1, except that the obtained non-aqueous electrolytes were used.

The batteries 45 to 48 were evaluated in the same manner as in Example 1. The results are shown in Table 7.

TABLE 7

| | | Cycle | Battery | Low-temperature |
|---|---|---|---|---|
| | | capacity | swelling | discharge |
| | Amount of | retention | after | capacity |
| | FB added | rate | cycling | retention |
| | (wt %) | (%) | (mm) | rate (%) |
| Battery 1 | Not added | 86.8 | 0.29 | 75.0 |
| Battery 45 | 1 | 86.9 | 0.29 | 75.1 |
| Battery 46 | 5 | 87.1 | 0.27 | 76.2 |
| Battery 47 | 10 | 87.6 | 0.25 | 76.6 |
| Battery 48 | 15 | 79.0 | 0.60 | 68.9 |

From Table 7, the batteries including an unsaturated sultone as the first additive and FB as the second additive in an amount of 1 to 10% by weight were excellent in the cycle capacity retention rate and the low-temperature discharge capacity retention rate. In addition, the battery swelling after cycling was small, indicating that the amount of generated gas was small. This is presumably because the addition of FB as the second additive decreased the viscosity of the non-aqueous electrolyte and improved the ion conductivity thereof, which suppressed the polarization during charging and discharging and improved the cycle characteristics and low-temperature discharge characteristics. Further, a partial increase in potential at the positive electrode and a Li deposition at the negative electrode were suppressed, which suppressed the gas generation associated with charge/discharge cycles.

### Example 9

Non-aqueous electrolytes were prepared in the same manner as in the battery 47 of Example 8, except that fluorinated aromatic compounds as shown in Table 8 were used as the second additive. Batteries 49 to 55 were fabricated in the same manner as the battery 47 of Example 8, except that the obtained non-aqueous electrolytes were used.

The batteries 49 to 55 were evaluated in the same manner as in Example 1. The results are shown in Table 8.

TABLE 8

| | | Cycle | Battery | Low-temperature |
|---|---|---|---|---|
| | | capacity | swelling | discharge |
| | | retention | after | capacity |
| | | rate | cycling | retention |
| | Second additive | (%) | (mm) | rate (%) |
| Battery 49 | 1,2- | 87.6 | 0.25 | 76.5 |
| | difluorobenzene | | | |
| Battery 50 | 1,2,3- | 87.1 | 0.27 | 76.3 |
| | trifluorobenzene | | | |
| Battery 51 | 1,2,3,4- | 87.4 | 0.28 | 76.2 |
| | tetrafluorobenzene | | | |
| Battery 52 | Pentafluorobenzene | 87.5 | 0.27 | 76.3 |
| Battery 53 | Hexafluorobenzene | 87.8 | 0.26 | 76.0 |
| Battery 54 | 2-fluorotoluene | 87.3 | 0.28 | 75.8 |
| Battery 55 | Trifluorotoluene | 87.0 | 0.27 | 75.7 |

The batteries including a fluorinated aromatic compound as shown in Table 8 as the second additive were excellent in the cycle capacity retention rate, and the battery swelling after cycling was small. The results show that these fluorinated aromatic compounds can be used with similar effects to those of fluorobenzene.

### Example 10

Non-aqueous electrolytes were prepared in the same manner as in the battery 21 of Example 4, except that FB was added as the second additive in an amount as shown in Table 9. Batteries 56 to 59 were fabricated in the same manner as the battery 21 of Example 4, except that the obtained non-aqueous electrolytes were used.

The batteries 56 to 59 were evaluated in the same manner as in Example 1. The results are shown in Table 9.

TABLE 9

| | | Cycle | Battery | Low-temperature |
|---|---|---|---|---|
| | | capacity | swelling | discharge |
| | Amount of | retention | after | capacity |
| | FB added | rate | cycling | retention |
| | (wt %) | (%) | (mm) | rate (%) |
| Battery 21 | Not added | 86.1 | 0.32 | 74.8 |
| Battery 56 | 1 | 86.2 | 0.32 | 75.0 |
| Battery 57 | 5 | 86.4 | 0.30 | 76.0 |
| Battery 58 | 10 | 87.0 | 0.28 | 76.3 |
| Battery 59 | 15 | 78.3 | 0.67 | 66.1 |

From Table 9, even when using methyl benzenesulfonate as the first additive, the batteries including FB as the second additive in an amount of 1 to 10% by weight were excellent in the cycle capacity retention rate and the low-temperature discharge capacity retention rate. In addition, the battery swelling after cycling was small, indicating that the amount of generated gas was small. The results show that effects due to the inclusion of the second additive can be exerted even when a sulfonic acid ester is used as the first additive.

### Example 11

Non-aqueous electrolytes were prepared in the same manner as in Example 1, except that ethyl propionate (EP) was added as the second additive in an amount as shown in Table 10. Batteries 60 to 63 were fabricated in the same manner as in Example 1, except that the obtained non-aqueous electrolytes were used.

The batteries 60 to 63 were evaluated in the same manner as in Example 1. The results are shown in Table 10.

TABLE 10

| | | Cycle | Battery | Low-temperature |
|---|---|---|---|---|
| | | capacity | swelling | discharge |
| | Amount of | retention | after | capacity |
| | EP added | rate | cycling | retention |
| | (wt %) | (%) | (mm) | rate (%) |
| Battery 1 | Not added | 86.8 | 0.29 | 75.0 |
| Battery 60 | 1 | 86.9 | 0.29 | 75.3 |
| Battery 61 | 5 | 87.2 | 0.26 | 78.6 |
| Battery 62 | 10 | 87.5 | 0.25 | 80.4 |
| Battery 63 | 15 | 78.8 | 0.61 | 68.0 |

From Table 10, the batteries including an unsaturated sultone as the first additive and EP as the second additive were excellent in the low-temperature discharge capacity retention rate. Among these, the batteries in which the weight percentage of EP was 1 to 10% by weight were excellent in the cycle capacity retention rate, and the battery swelling after cycling was small, indicating that the amount of generated gas was small. This is presumably because the addition of EP as the second additive decreased the viscosity of the non-aqueous electrolyte and improved the ion conductivity thereof, which suppressed the polarization during charging and discharging and improved the cycle characteristics and low-temperature discharge characteristics. Further, a partial increase in potential at the positive electrode and a Li deposition at the negative electrode were suppressed, which suppressed the gas generation associated with charge/discharge cycles.

### Example 12

Non-aqueous electrolytes were prepared in the same manner as in the battery 62 of Example 11, except that fatty acid alkyl esters as shown in Table 11 were used as the second additive. Batteries 64 to 67 were fabricated in the same manner as the battery 62 of Example 11, except that the obtained non-aqueous electrolytes were used.

The batteries 64 to 67 were evaluated in the same manner as in Example 1. The results are shown in Table 11.

TABLE 11

| | | Cycle | Battery | Low-temperature |
|---|---|---|---|---|
| | | capacity | swelling | discharge |
| | | retention | after | capacity |
| | | rate | cycling | retention |
| | Second additive | (%) | (mm) | rate (%) |
| Battery 64 | Methyl butyrate | 87.8 | 0.23 | 76.9 |
| Battery 65 | Ethyl butyrate | 87.3 | 0.26 | 76.5 |
| Battery 66 | Methyl pentanoate | 87.5 | 0.26 | 76.3 |
| Battery 67 | Ethyl pentanoate | 87.4 | 0.25 | 76.1 |

The batteries including a fatty acid alkyl ester as shown in Table 11 as the second additive were excellent in the cycle capacity retention rate and the low-temperature discharge capacity retention rate, and the battery swelling after cycling was small, indicating that the amount of generated gas was small. The results show that these fatty acid alkyl esters can be used with similar effects to those of ethyl propionate.

### Example 13

Non-aqueous electrolytes were prepared in the same manner as in the battery 21 of Example 4, except that ethyl propionate was added as the second additive in an amount as shown in Table 12. Batteries 68 to 71 were fabricated in the same manner as the battery 21 of Example 4, except that the obtained non-aqueous electrolytes were used.

The batteries 68 to 71 were evaluated in the same manner as in Example 1. The results are shown in Table 12.

TABLE 12

| | | Cycle | Battery | Low-temperature |
|---|---|---|---|---|
| | | capacity | swelling | discharge |
| | Amount of | retention | after | capacity |
| | EP | rate | cycling | retention |
| | (wt %) | (%) | (mm) | rate (%) |
| Battery 21 | Not added | 86.2 | 0.32 | 74.8 |
| Battery 68 | 1 | 86.3 | 0.31 | 75.1 |
| Battery 69 | 5 | 86.9 | 0.28 | 78.5 |
| Battery 70 | 10 | 87.0 | 0.27 | 80.2 |
| Battery 71 | 15 | 76.5 | 0.68 | 65.9 |

From Table 12, even when including methyl benzenesulfonate as the first additive, the batteries including EP as the second additive were excellent in the low-temperature discharge capacity retention rate. Among these, the batteries in which the weight percentage of EP was 1 to 10% by weight were excellent in the cycle capacity retention rate, and the battery swelling after cycling was small, indicating that the amount of generated gas was small. The results show that effects due to the inclusion of the second additive can be exerted even when a sulfonic acid ester is used as the first additive.

### INDUSTRIAL APPLICABILITY

By using the non-aqueous electrolyte of the present invention, it is possible to suppress the reduction in the charge/discharge capacity of non-aqueous electrolyte secondary batteries during storage in a high temperature environment and during charge/discharge cycles, as well as to achieve excellent low-temperature characteristics. The non-aqueous electrolyte secondary battery of the present invention is useful for cellular phones, personal computers, digital still cameras, game machines, mobile audio devices, and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

20 Battery can

21 Electrode assembly

22 Positive electrode lead

23 Negative electrode lead

24 Insulator

25 Sealing plate

26 Insulating gasket

29 Sealing stopper

1. A non-aqueous electrolyte comprising a non-aqueous solvent and a solute dissolved in the non-aqueous solvent, wherein:
the non-aqueous solvent includes ethylene carbonate, propylene carbonate, diethyl carbonate, and a first additive;
a weight percentage W_{PC} of the propylene carbonate relative to a total of the ethylene carbonate, the propylene carbonate, and the diethyl carbonate is 30 to 60% by weight;
a ratio W_{PC}/W_{EC} of the weight percentage W_{PC} of the propylene carbonate to a weight percentage W_{PC} of the ethylene carbonate relative to the total satisfies 2.25≦W_{PC}/W_{PC}≦6; and
the first additive comprises at least one of an unsaturated sultone and a sulfonic acid ester, and a weight percentage of the first additive in the whole non-aqueous electrolyte is 0.1 to 3% by weight.

2. The non-aqueous electrolyte in accordance with claim 1, wherein the unsaturated sultone is a compound represented by the following formula (1): 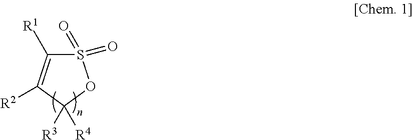
where n is an integer of 1 to 3; R¹ to R⁴ are independently a hydrogen atom, a fluorine atom, or an alkyl group; and at least one hydrogen atom in the alkyl group may be replaced with a fluorine atom.

3. The non-aqueous electrolyte in accordance with claim 1, wherein the sulfonic acid ester is a compound represented by the following formula (2): 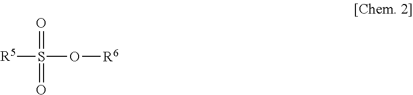
where R⁵ and R⁶ are independently an alkyl group or an aryl group; and at least one hydrogen atom in the alkyl group or the aryl group may be replaced with a fluorine atom.

4. The non-aqueous electrolyte in accordance with claim 1, wherein the weight percentage W_{EC} of the ethylene carbonate is 5 to 20% by weight, and a weight percentage W_{DEC} of the diethyl carbonate relative to the total is 30 to 65% by weight.

5. The non-aqueous electrolyte in accordance with claim 1, wherein the non-aqueous solvent includes a second additive comprising at least one of a fluorinated aromatic compound and a fatty acid alkyl ester, and a weight percentage of the second additive in the whole non-aqueous electrolyte is 10% by weight or less.

6. A non-aqueous electrolyte secondary battery comprising a positive electrode, a negative electrode, a separator interposed between the positive electrode and the negative electrode, and the non-aqueous electrolyte of claim 1, wherein:
the negative electrode includes a negative electrode core material and a negative electrode material mixture layer adhering to the negative electrode core material; and
the negative electrode material mixture layer includes graphite particles, a water-soluble polymer coated on surfaces of the graphite particles, and a binder for bonding together the graphite particles coated with the water-soluble polymer.

7. The non-aqueous electrolyte secondary battery in accordance with claim 6, wherein the non-aqueous electrolyte secondary battery has been subjected to at least one charge and discharge operation.

8. The non-aqueous electrolyte secondary battery in accordance with claim 6, wherein the water-soluble polymer comprises a cellulose derivative or a polyacrylic acid.

9. The non-aqueous electrolyte secondary battery in accordance with claim 6, wherein a penetration rate of water into the negative electrode material mixture layer is from 3 to 40 seconds.

10. The non-aqueous electrolyte secondary battery in accordance with claim 7, wherein the weight percentage of the first additive in the whole non-aqueous electrolyte is 0.01 to 2.95% by weight.

11. A non-aqueous electrolyte secondary battery comprising a positive electrode, a negative electrode, a separator interposed between the positive electrode and the negative electrode, and a non-aqueous electrolyte, wherein:
the negative electrode includes a negative electrode core material and a negative electrode material mixture layer adhering to the negative electrode core material;
the negative electrode material mixture layer includes graphite particles, a water-soluble polymer coated on surfaces of the graphite particles, and a binder for bonding together the graphite particles coated with the water-soluble polymer;
the non-aqueous electrolyte includes a non-aqueous solvent and a solute dissolved in the non-aqueous solvent;
the non-aqueous solvent includes ethylene carbonate, propylene carbonate, diethyl carbonate, and a first additive;
a weight percentage W_{PC} of the propylene carbonate relative to a total of the ethylene carbonate, the propylene carbonate, and the diethyl carbonate is 30 to 60% by weight;
a ratio W_{PC}/W_{EC} of the weight percentage W_{PC} of the propylene carbonate to a weight percentage W_{FC} of the ethylene carbonate relative to the total satisfies 2.25≦W_{PC}/W_{EC}≦6; and
the first additive comprises at least one of an unsaturated sultone and a sulfonic acid ester, and a weight percentage of the first additive in the whole non-aqueous electrolyte is 0.01 to 2.95% by weight.
